(19) United States
(12) Patent Application Publication
(10) Pub. No.: US 2024/0097222 A1
(43) Pub. Date: Mar. 21, 2024

(54) SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Yasunobu YAMASHITA, Tokyo (JP); Keigo HOSHINA, Tokyo (JP); Shinsuke MATSUNO, Tokyo (JP)

(73) Assignee: KABUSHIKI KAISHA TOSHIBA, Tokyo (JP)

(21) Appl. No.: 18/176,079

(22) Filed: Feb. 28, 2023

(30) Foreign Application Priority Data
Sep. 20, 2022 (JP) 2022-148781

(51) Int. Cl. H01M 10/52; H01M 10/0525

(52) U.S. Cl. CPC H01M 10/526; H01M 10/0525; H01M 2220/20

(57) ABSTRACT

In general, according to one embodiment, a secondary battery includes a positive electrode, a negative electrode, an aqueous electrolyte, and a gas treatment structure. The gas treatment structure is configured to be capable of treating hydrogen gas using an electrical conduction between the gas treatment structure and the positive electrode.

### CROSS-REFERENCE TO RELATED APPLICATIONS

This application is based upon and claims the benefit of priority from Japanese Patent Application No. 2022-148781, filed Sep. 20, 2022, the entire contents of which are incorporated herein by reference.

### FIELD

Embodiments relate to a secondary battery, a battery pack, a vehicle, and a stationary power source.

### BACKGROUND

A lithium ion secondary battery including an aqueous electrolyte generates a gas mainly including H₂ in charge and discharge, unlike a lithium ion secondary battery including a non-aqueous electrolyte. In addition, since a lithium ion secondary battery including an aqueous electrolyte, does not generate O₂ unlike a lead-acid battery, it is difficult to deal with the generated gas by a gas treatment method based on recombination of H₂ and O₂.

Regarding the treatment of a gas generated inside a battery, there are reports on chemical recombination using a catalyst or a hydrogen storage alloy for a nickel-metal hydride rechargeable battery (Ni-MH) or a lead-acid battery. In addition, there are reports on absorption in an alloy for a lithium ion secondary battery including a non-aqueous electrolyte.

However, these methods are limited to a nickel-metal hydride rechargeable battery in which H₂ and O₂ coexist in the battery, a lead-acid battery, or a lithium ion secondary battery including a non-aqueous electrolytic solution that has a relatively high dissolved amount of H₂. There is an issue that these methods cannot be applied to a lithium ion secondary battery including an aqueous electrolyte that does not satisfy these conditions.

### BRIEF DESCRIPTION OF THE DRAWINGS

FIG. 1 is a plan view of an example of a secondary battery according to an embodiment.

FIG. 2 is a cross-sectional view of a stack included in the secondary battery illustrated in FIG. 1 taken along a thickness direction.

FIG. 3 is a cross-sectional view of an electrode group of the secondary battery illustrated in FIG. 1 taken along the thickness direction.

FIG. 4 is a plan view of another example of the secondary battery according to the embodiment.

FIG. 5 is a diagram illustrating an electric circuit for a configuration of a part of the secondary battery according to the embodiment.

FIG. 6 is a perspective view of another example of a gas treatment structure of the secondary battery according to the embodiment.

FIG. 7 is a cross-sectional view of still another example of a gas treatment structure of the secondary battery according to the embodiment.

FIG. 8 is a perspective view of still another example of the secondary battery according to the embodiment.

FIG. 9 is an exploded perspective diagram schematically illustrating an example of a battery pack according to an embodiment.

FIG. 10 is a block diagram illustrating an example of an electric circuit of the battery pack illustrated in FIG. 8.

FIG. 11 is a partially transparent diagram schematically illustrating an example of a vehicle according to an embodiment.

FIG. 12 is a block diagram illustrating an example of a system including a stationary power source according to an embodiment.

### DETAILED DESCRIPTION

In general, according to one embodiment, a secondary battery is provided. The secondary battery includes a positive electrode, a negative electrode, an aqueous electrolyte, and a gas treatment structure. The gas treatment structure is configured to be capable of treating hydrogen gas using an electrical conduction between the gas treatment structure and the positive electrode.

According to another embodiment, a battery pack includes the secondary battery according to the embodiment.

According to another embodiment, a vehicle includes the battery pack according to the embodiment.

According to another embodiment, a stationary power source includes the battery pack according to the embodiment.

Hereinafter, embodiments will be described with reference to the drawings. In the following description, components having substantially identical functions and configurations are denoted by identical reference numerals, and repeated description of these components may be omitted. The drawings are schematic, and the relationship between thickness and plane dimension, the ratio of thicknesses of layers, and the like may be different from actual ones. In addition, the drawings may include portions having different dimensional relationships and ratios. All statements about one embodiment also apply as statements about another embodiment unless they are expressly or explicitly excluded. Each embodiment exemplifies an apparatus and a method for embodying the technical idea of this embodiment, and the technical idea of the embodiment does not specify the materials, shapes, structures, arrangements, and the like of the components as follows.

### First Embodiment

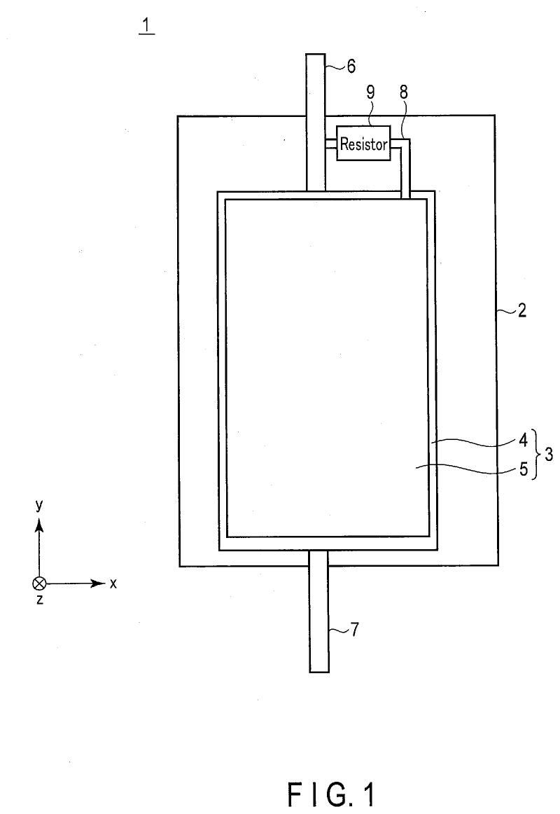

A secondary battery of a first embodiment will be described with reference to FIGS. 1 to 8. FIG. 1 is a plan view of an example of the secondary battery in which a container member is partially cut out in order to facilitate understanding of a structure in the container member. As illustrated in FIG. 1, a secondary battery 1 includes a container member 2 and a stack 3 housed in the container member 2. The stack 3 includes an electrode group 4 and a gas treatment structure 5. The secondary battery 1 further includes a positive electrode terminal 6 electrically connected to positive electrodes of the electrode group 4, a negative electrode terminal 7 electrically connected to negative electrodes of the electrode group 4, a wiring 8 for electrically connecting the positive electrode terminal 6 and the gas treatment structure 5, and a resistor 9 interposed in the wiring 8. In FIG. 1, the main surface of the electrode group 4 is parallel to an x-y plane, and the thickness direction of the electrode group 4 is parallel to a z-axis direction. The main surface of the electrode group 4 has a rectangular shape. The long-side direction of the electrode group 4 is parallel to a y-axis direction, and the short-side direction of the electrode group 4 is parallel to an x-axis direction.

As illustrated in FIG. 3, the electrode group 4 is a stacked electrode group. The stacked electrode group 4 has a structure in which a positive electrode 10 and a negative electrode 11 are alternately stacked with a separator 12 interposed therebetween. The electrode group 4 includes a plurality of positive electrodes 10. Each of the plurality of positive electrodes 10 includes a positive electrode current collector 10a and positive electrode mixture layers 10b supported on both surfaces of the positive electrode current collector 10a. The electrode group 4 also includes a plurality of negative electrodes 11. Each of the plurality of negative electrodes 11 includes a negative electrode current collector 11a and negative electrode mixture layers 11b supported on both surfaces of the negative electrode current collector 11a.

The positive electrode current collector 10a of each positive electrode 10 includes, on one side thereof, a portion where the positive electrode mixture layer 10b is not supported on any surface. The portions serve as positive electrode tabs. The portions serving as the positive electrode tabs do not overlap with the negative electrodes 11. The plurality of positive electrode tabs is electrically connected to the belt-shaped positive electrode terminal 6. The leading end of the belt-shaped positive electrode terminal 6 is drawn out of the container member 2.

As illustrated in FIG. 3, the negative electrode current collector 11a of each negative electrode 11 includes, on one side thereof, a portion 11c where the negative electrode mixture layer 11b is not supported on any surface. The portions 11c serve as negative electrode tabs. The negative electrode tabs do not overlap with the positive electrodes 10. The negative electrode tabs are located on the opposite side of the electrode group 4 with respect to the positive electrode tabs. The negative electrode tabs are electrically connected to the belt-shaped negative electrode terminal 7. The leading end of the belt-shaped negative electrode terminal 7 is located on the side opposite to the positive electrode terminal 6 and is drawn out of the container member 2.

The electrode group 4 holds an aqueous electrolyte (not illustrated).

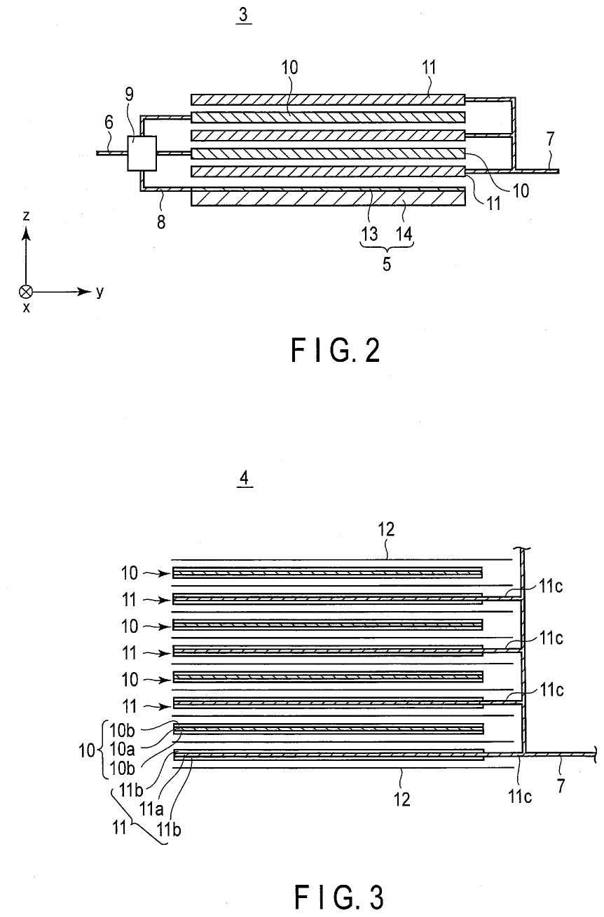

FIG. 2 is a cross-sectional view of the stack 3 taken along the stacking direction (the z-axis direction in FIG. 1). In the electrode group 4 illustrated in FIG. 2, the separator 12 is omitted for convenience of description. The gas treatment structure 5 is arranged on one main surface side of the electrode group 4. Here, the main surface of the electrode group 4 is a surface parallel to the xy plane in FIG. 2. The gas treatment structure 5 may be in contact with the main surface of the electrode group 4 or may be arranged with a gap from the main surface of the electrode group 4. The gas treatment structure 5 includes a conductive porous substrate 13 and a gas treatment layer 14 supported or stacked on one main surface (a surface parallel to the xy plane) of a porous substrate 13. The gas treatment layer 14 contains a noble metal catalyst, for example. The main surface of the porous substrate 13 in the gas treatment structure 5 faces the electrode group 4. The porous substrate 13 is located between the gas treatment layer 14 of the gas treatment structure 5 and the electrode group 4. The porous substrate 13 may be in contact with the electrode group 4 or may have a gap from the electrode group 4. One end of the wiring 8 is electrically connected to the porous substrate 13. The wiring 8 is electrically connected to the positive electrode terminal 6 via the resistor 9. In FIG. 2, the main surface of the porous substrate 13 in the gas treatment structure 5 faces the electrode group 4. Alternatively, the main surface of the gas treatment layer 14 may be in contact with the electrode group 4 or may face the electrode group 4 with a gap therebetween.

The container member 2 is formed of a laminate film including a metal layer, for example. The container member 2 is sealed in a state where the respective leading ends of the positive electrode terminal 6 and negative electrode terminal 7 protrude along the y-axis direction in FIG. 1.

In the secondary battery including the aqueous electrolyte described above, for example, electrolysis of water occurs during float charge or charge-and-discharge cycles, thereby to generate hydrogen gas. The hydrogen gas passes through the porous substrate 13 in the gas treatment structure 5 and reaches the gas treatment layer 14 in the container member 2. The gas treatment structure 5 is electrically conductive to the positive electrode terminal 6 of the positive electrodes 10 via the resistor 9. Therefore, in the gas treatment layer 14, the hydrogen gas is converted into water according to the following reaction formula (A). This reaction can occur at a potential of E₀ of −0.83 V.

Chem 1

H₂(g)+2OH⁻→2H₂O+2e⁻ (A)

The hydrogen gas is consumed by the above reaction. In addition, the generated water can function as a solvent of the aqueous electrolyte. On the other hand, in the positive electrodes 10, self-discharge may occur according to the reaction formula (B), for example. The reaction formula (B) indicates a discharge reaction of the positive electrodes when LiMn₂O₄ is used as a positive electrode active material. This discharge reaction can occur at a potential of E₀ of +0.95 V.

Chem 2

Mn₂O₄+Li⁺+e⁻→LiMn₂O₄ (B)

The total reaction formula combining the formula (A) and the formula (B) is represented in the following (C).

Chem 3

Mn₂O₄+LiOH+½H₂(g)→LiMn₂O₄+H₂O (C)

Electromotive force E of the reaction in the formula (C) is 1.78 V.

As described above, bringing the gas treatment structure 5 into conduction with the positive electrodes 10 makes it possible to cause a spontaneous recombination reaction between a gas phase H₂ and hydroxide ions (OH⁻) at an electromotive force of about 1.78 V while involving self-discharge of the positive electrodes. As a result, accumulation of hydrogen gas in the secondary battery can be suppressed, so that it is possible to suppress an increase in internal pressure of the secondary battery and improve the charge-discharge efficiency. If a gas accumulates inside the battery, liquid junction on the electrode surface is inhibited to reduce the electrode surface area that can contribute to charge and discharge. This reduces the discharge capacity. Accordingly, the charge-discharge efficiency decreases. In addition, since self-discharge of the positive electrodes also occurs in the process of treating the hydrogen gas, it is also possible to suppress over-charge of the positive electrode. Furthermore, since the gas treatment structure 5 is electrically connected to the positive electrodes 10 via the resistor 9, the current flowing through the gas treatment structure 5 can be controlled to be constant. This makes it possible to prevent the self-discharge amount of the positive electrodes from becoming too large, so that over-discharge of the positive electrodes can be prevented.

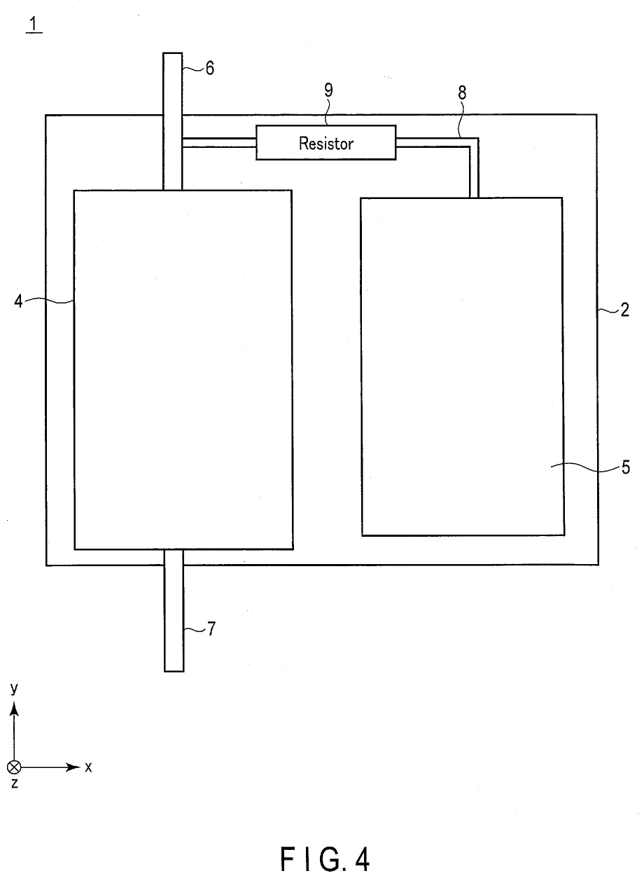

In FIGS. 1 to 3, the gas treatment structure 5 is arranged on the electrode group 4. However, the arrangement of the gas treatment structure 5 is not limited thereto. For example, as illustrated in FIG. 4, the gas treatment structure 5 may be arranged next to the electrode group 4 in the short-side direction (x-axis direction in FIG. 1) of the electrode group 4. At this time, a clearance may be provided between the electrode group 4 and the gas treatment structure 5. The embodiment is not limited to this arrangement, and the gas treatment structure 5 may be arranged next to the electrode group 4 in the long-side direction (y-axis direction in FIG. 1) of the electrode group 4.

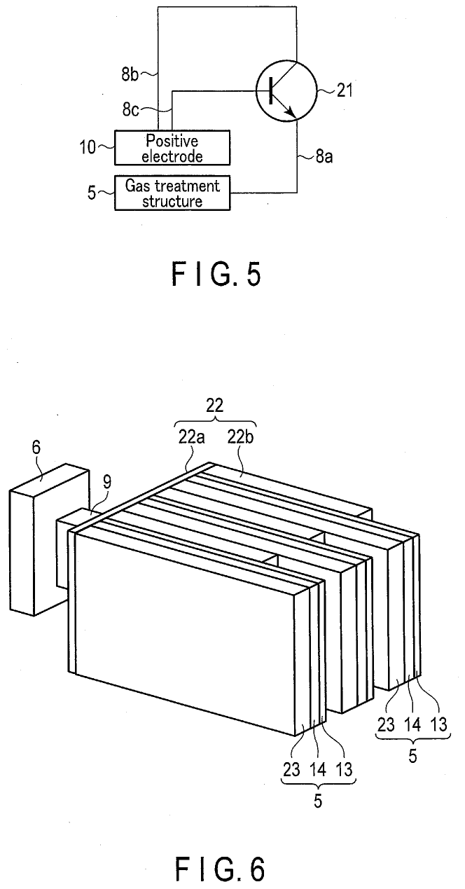

In FIGS. 1 to 4, the gas treatment structure 5 is electrically connected to the positive electrodes 10 via the resistor 9, but the present embodiments are not limited thereto. A switching element can be used instead of the resistor. This example will be described with reference to FIG. 5. FIG. 5 is a circuit diagram illustrating an electric circuit of a portion including the gas treatment structure 5 and the positive electrode 10. A switching element 21 such as a transistor is electrically connected to the gas treatment structure 5 by a wiring 8a. In addition, the switching element 21 is electrically connected to the positive electrode 10 by a wiring 8b, and is configured to receive, as a signal, application of a predetermined voltage between the gas treatment structure 5 and the positive electrode 10 via a wiring 8c. According to the above configuration, the potential difference between the positive electrode 10 and the gas treatment structure 5 increases as the charge of the positive electrode 10 progresses and the positive electrode potential increases (the positive electrode potential shifts to the noble side). Accordingly, when a predetermined voltage is applied between the gas treatment structure 5 and the positive electrode 10, the voltage is transmitted as an electric signal to the switching element 21 via the wiring 8c. As a result, the switching element 21 turns on conduction between the gas treatment structure 5 and the positive electrode 10, so that a current flows between the gas treatment structure 5 and the positive electrode 10. Thus, the gas treatment structure 5 can treat hydrogen gas according to the formula (A). When the voltage application between the gas treatment structure 5 and the positive electrode 10 is terminated, this is transmitted as an electric signal to the switching element 21 via the wiring 8c. As a result, the switching element 21 turns off the conduction between the gas treatment structure 5 and the positive electrode 10, so that the gas treatment structure 5 and the positive electrode 10 are electrically insulated. Thus, the treatment of hydrogen gas by the gas treatment structure 5 can be stopped. Therefore, when charging of the positive electrode 10 progresses and the internal pressure of the secondary battery increases, a necessary current flows through the gas treatment structure 5 so that gas treatment can be performed.

In the secondary battery of the embodiment, the gas treatment structure 5 may be directly electrically connected to the positive electrode 10 without interposing a resistor or a switching element. As an example, the porous substrate 13 of the gas treatment structure 5 and the positive electrode 10 may be brought into direct physical contact with each other, or the porous substrate 13 of the gas treatment structure 5 and the positive electrode 10 may be electrically connected by wiring or the like.

In FIGS. 1 to 4, the gas treatment structure 5 includes the conductive porous substrate 13 and the gas treatment layer 14, but the gas treatment structure 5 is not limited to this configuration. In order to enhance the treatment capability of the gas treatment structure, the gas treatment structure 5 may include a plurality of conductive porous substrates 13 and gas treatment layers 14. FIG. 6 illustrates this example. As illustrated in FIG. 6, the gas treatment structure 5 is electrically connected to the resistor 9 electrically connected to positive electrode terminal 6, by the conductive member 22. The gas treatment structure 5 includes a plurality of conductive porous substrates 13, a plurality of gas treatment layers 14, and a plurality of electrolyte layers 23. The gas treatment layers 14 are arranged on the corresponding porous substrates 13. The electrolyte layers 23 are arranged on the corresponding gas treatment layers 14. The electrolyte layers 23 contain an aqueous electrolyte. The gas treatment structure 5 is arranged such that surfaces with the electrolyte layers 23 are oriented in the same direction. The conductive member 22 includes a first conductive plate 22a made of a Ti plate and a plurality of second conductive plates 22b protruding from one surface of the first conductive plate 22a, for example. The resistor 9 is electrically connected to the other surface of the first conductive plate 22a. The plurality of second conductive plates 22b are made of Ti foil, for example, and are spaced on one surface of the first conductive plate 22a. The second conductive plates 22b are in contact with the corresponding porous substrates 13 of the gas treatment structure 5. The gas treatment structure 5 described above can increase the area of contact with hydrogen gas, and thus can enhance treatment capability. In addition, since the electrolyte layers 23 can retain water molecules generated according to the reaction formula (A), the water content of the porous substrates 13 can be maintained at a low value. As a result, hydrogen gas can be smoothly supplied from the porous substrates 13 to the gas treatment layers 14. The electrolyte layers 23 can supply OH⁻ represented in the reaction formula (A) to the gas treatment layers 14. As a result, the hydrogen gas treatment capability of the gas treatment structure 5 can be enhanced.

The electrolyte layers 23 are not particularly limited as long as they contain an aqueous electrolyte. Examples of the electrolyte layers 23 include gel electrolyte layers containing an aqueous electrolyte, porous membranes holding an aqueous electrolyte, and the like. The aqueous electrolyte may have a composition that is identical to or different from the aqueous electrolyte contained in the secondary battery.

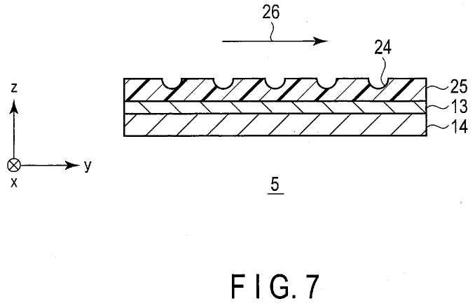

In FIGS. 1 to 4, the gas treatment structure 5 includes the conductive porous substrate 13 and the gas treatment layer 14, but the gas treatment structure 5 is not limited to this configuration. The gas treatment structure 5 may further include a layer having a gas flow path. This example will be described with reference to FIG. 7. The gas treatment structure 5 further includes a layer 25 having a gas flow path 24 supported on the other main surface of the conductive porous substrate 13. The gas flow path 24 is a recess formed on the surface of the layer 25. The number of the gas flow path(s) 24 can be one or more. In FIG. 7, a plurality of gas flow paths 24 are provided at predetermined intervals along one direction 26 (for example y direction) on the surface of the layer 25. The plurality of gas flow paths 24 may be provided at predetermined intervals along x direction on the surface of the layer 25. Providing the layer having a gas flow path makes it possible to more smoothly supply the gas generated from the electrode group to the gas treatment layer 14. Examples of the layer having a gas flow path include a fluororesin sheet having a recess. Examples of the fluororesin include polytetrafluoroethylene (PTFE).

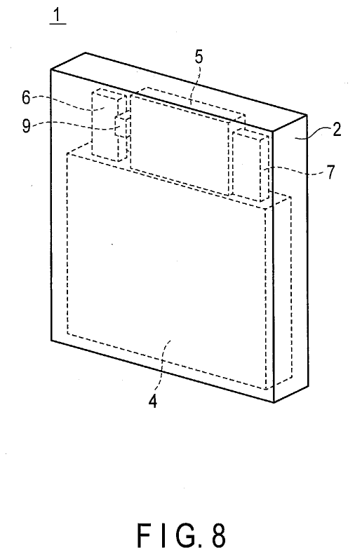

In FIGS. 1 to 4, the direction in which the positive electrode terminal 6 of the electrode group 4 extends and the direction in which the negative electrode terminal 7 extends are opposite to each other as an example, but the present embodiments are not limited thereto. For example, as illustrated in FIG. 8, the direction in which the positive electrode terminal 6 extends and the direction in which the negative electrode terminal 7 extends may be the same. The positive electrode terminal 6 and the negative electrode terminal 7 extend in the same direction from one end surface of the electrode group 4. The positive electrode terminal 6 and the negative electrode terminal 7 are spaced from each other. The gas treatment structure 5 is arranged in a space between the positive electrode terminal 6 and the negative electrode terminal 7. The gas treatment structure 5 is electrically connected to the positive electrode terminal 6 via the resistor 9. According to this secondary battery, a dead space existing between the positive electrode terminal 6 and the negative electrode terminal 7 can be effectively utilized. In addition, the gas treatment structure 5 can be prevented from being completely impregnated with the aqueous electrolyte, so that it is possible to smoothly supply gas to the gas treatment structure 5.

Hereinafter, the gas treatment structure, the positive electrode, the negative electrode, the aqueous electrolyte, the separator, the container member, the positive electrode terminal, and the negative electrode terminal included in the secondary battery of the embodiment will be described.

### (Gas Treatment Structure)

The gas treatment structure includes a conductive porous substrate and a gas treatment layer. The gas treatment layer is arranged on at least one surface (for example, a main surface) of the conductive porous substrate. In the reaction of treating hydrogen gas by an oxidation reaction, water is produced as exemplified in (A). Arranging the gas treatment layer only on one surface of the conductive porous substrate makes it possible to suppress the conductive porous substrate from being wetted with water, so that gas can be smoothly supplied from the conductive porous substrate to the gas treatment layer.

It is desirable to use a conductive gas diffusion layer (GDL) for the conductive porous substrate. Examples of the conductive gas diffusion layer include carbon paper.

The gas treatment layer contains at least one of a hydrogen storage alloy or a noble metal catalyst. The gas treatment layer can treat hydrogen gas by being electrically connected to the positive electrode. The hydrogen storage alloy is not particularly limited as long as it can store hydrogen. Examples of the hydrogen storage alloy include LaNi₅ series such as LaNi_{4.7}Al_{0.3}.

An example of hydrogen storage reaction by the gas treatment layer containing a hydrogen storage alloy is shown in the following reaction formula (D):

Chem 4

M+H₂O+e⁻MH+OH⁻ (D)

The reaction formula (D) can occur at a potential of E₀ of −0.83 V. A reaction formula between the gas treatment layer containing a hydrogen storage alloy and the positive electrode containing LiMn₂O₄ as a positive electrode active material is illustrated in the following (E):

Chem 5

Mn₂O₄+LiOH+MH→LiMn₂O₄+M+H₂O (E)

The electromotive force E in the reaction formula (E) is 1.78 V.

The noble metal catalyst is not particularly limited as long as it accelerates the oxidation reaction of H₂. Examples of the noble metal catalyst include a platinum catalyst (Pt/C) supported on a carbon material.

The gas treatment layer containing a noble metal catalyst is obtained by dispersing a noble metal catalyst and a binder in a solvent to prepare a paste, applying the obtained paste to a conductive porous substrate, and drying the paste, for example. Examples of the binder include polytetrafluoroethylene (PTFE), polyvinylidene fluoride (PVdF), a perfluoroalkylsulfonic acid-based polymer, and a fluorine-based ion exchange membrane. The kind of the binder may be one kind or two or more kinds. Examples of the solvent include N-methyl pyrrolidone (NMP).

### (Positive Electrode)

The positive electrode includes a positive electrode current collector and a positive electrode mixture layer (positive electrode active material-containing layer) supported on at least one surface of the positive electrode current collector.

The positive electrode mixture layer may be formed on one side or both sides of the current collector. The positive electrode mixture layer can contain a positive electrode active material, and optionally a conductive agent and a binder.

As the positive electrode active material, for example, an oxide or a sulfide can be used. The positive electrode may contain one kind of compound alone or two or more kinds of compounds in combination as the positive electrode active material. Examples of the oxides and sulfides include compounds capable of inserting and extracting Li or Li ions.

Examples of such compounds include manganese dioxide (MnO₂), iron oxide, copper oxide, nickel oxide, lithium manganese composite oxide (for example, LixMn₂O₄ or LiₓMnO₂, 0<x≤1), lithium nickel composite oxide (for example, LiₓNiO₂; 0<x≤1), lithium-cobalt composite oxide (for example, LiₓCoO₂; 0<x≤1), lithium nickel cobalt composite oxide (for example, LiₓNi_{1-y}Co_{y}O₂; 0<x≤1, 0<y<1), lithium manganese cobalt composite oxide (for example, LiₓMn_{y}Co_{1-y}O₂; 0<x≤1, 0<y<1), lithium manganese nickel composite oxide having a spinel structure (for example, LiₓMn_{2-y}Ni_{y}O₄; 0<x≤1, 0<y<2), lithium phosphorus oxide having an olivine structure (for example, LiₓFePO₄; 0<x≤1, LiₓFe_{1-y}Mn_{y}PO₄; 0<x≤1, 0<y<1, LiₓCoPO₄; 0<x≤1), iron sulfate (Fe₂(SO₄)₃), vanadium oxide (for example, V₂O₅), and lithium nickel cobalt manganese composite oxide (LiₓNi_{1-y-z}Co_{y}Mn_{z}O₂; 0<x≤1, 0<y<1, 0<z<1, y+z<1).

Among the above, examples of the compound more preferable as the positive electrode active material include a lithium-manganese composite oxide having a spinel structure (for example, LiₓMn₂O₄; 0<x≤1), lithium nickel composite oxide (for example, LiₓNiO₂; 0<x≤1), lithium-cobalt composite oxide (for example, LiₓCoO₂; 0<x≤1), lithium nickel cobalt composite oxide (for example, LiₓNi_{1-y}Co_{y}O₂; 0<x≤1, 0<y<1), lithium manganese nickel composite oxide having a spinel structure (for example, LiₓMn_{2-y}Ni_{y}O₄; 0<x≤1, 0<y<2), lithium manganese cobalt composite oxide (for example, LiₓMn_{y}Co_{1-y}O₂; 0<x≤1, 0<y<1), lithium iron phosphate (for example, LiₓFePO₄; 0<x≤1), and lithium-nickel-cobalt-manganese composite oxide (LiₓNi_{1-y-z}Co_{y}Mn_{z}O₂; 0<x≤1, 0<y<1, 0<z<1, y+z<1). Using at least one of these compounds for the positive electrode active material increases the positive electrode potential.

In a case of using a room temperature molten salt as the electrolyte of the battery, it is preferable to use a positive electrode active material containing lithium iron phosphate, LiₓVPO₄F (0≤x≤1), lithium manganese composite oxide, lithium nickel composite oxide, lithium nickel cobalt composite oxide, or a mixture thereof.

The primary particle size of the positive electrode active material is preferably 100 nm or more and 1 μm or less. The positive electrode active material having a primary particle size of 100 nm or more is easy to handle in industrial production. The positive electrode active material having a primary particle size of 1 μm or less can smoothly diffuse lithium ions in a solid.

The specific surface area of the positive electrode active material is preferably 0.1 m²/g or more and 10 m²/g or less. The positive electrode active material having a specific surface area of 0.1 m²/g or more can sufficiently secure inserted/extracted sites of Li ions. The positive electrode active material having a specific surface area of 10 m²/g or less is easy to handle in industrial production, and can ensure good charge-and-discharge cycle performance.

The binder is blended to fill gaps in the dispersed positive electrode active material and to bind the positive electrode active material and the positive electrode current collector. Examples of the binder include polytetrafluoroethylene (PTFE), polyvinylidene fluoride (PVdF), fluororubber, polyacrylic acid compound, imide compound, carboxymethyl cellulose (CMC), and salts of CMC. One of them may be used as a binder, or two or more of them may be used in combination as a binder.

The conductive agent is blended in order to enhance current collection performance and to suppress contact resistance between the positive electrode active material and the positive electrode current collector. Examples of the conductive agent include vapor grown carbon fiber (VGCF), carbon black such as acetylene black, and carbonaceous materials such as graphite, carbon nanofibers, and carbon nanotubes. One of them may be used as a conductive agent, or two or more of them may be used in combination as a conductive agent. The conductive agent can be omitted.

In the positive electrode mixture layer, the positive electrode active material and the binder are preferably blended in proportions of 80 mass % or more and 98 mass % or less and 2 mass % or more and 20 mass % or less, respectively.

Setting the amount of the binder to 2 mass % or more makes it possible to obtain sufficient electrode strength. The binder can also function as an insulator. Therefore, setting the amount of the binder to 20 mass % or less decreases the amount of the insulator contained in the electrode, so that the internal resistance can be reduced.

In a case of adding the conductive agent, the positive electrode active material, the binder, and the conductive agent are preferably blended in proportions of 77 mass % or more and 95 mass % or less, 2 mass % or more and 20 mass % or less, and 3 mass % or more and 15 mass % or less, respectively.

Setting the amount of the conductive agent to 3 mass % or more, the above-described advantageous effect can be produced. In addition, setting the amount of the conductive agent to 15 mass % or less decreases the proportion of the conductive agent in contact with the electrolyte. If this proportion is low, decomposition of the electrolyte can be reduced under high temperature storage.

A material used for the current collector of the positive electrode is a material that is electrochemically stable at a potential at which lithium (Li) is inserted into and extracted from the active material, for example. For example, the positive electrode current collector may be a metal foil containing one or more elements selected from among nickel, stainless steel, aluminum, an aluminum alloy (aluminum alloy containing one or more elements selected from among Mg, Ti, Zn, Mn, Fe, Cu, and Si, for example), Mg, Ti, Zn, Mn, Fe, Cu, and Si. The thickness of the positive electrode current collector is preferably 5 μm or more and 20 μm or less. The current collector having such a thickness can balance the strength and weight reduction of the electrode.

The current collector may include a portion where the mixture layer is not formed on the surface thereof. This portion can serve as a current collecting tab or a current collecting lead.

### (Negative Electrode)

The negative electrode includes a negative electrode current collector and a negative electrode mixture layer (negative electrode active material-containing layer) supported on at least one surface of the negative electrode current collector.

The negative electrode mixture layer may be formed on one side or both sides of the negative electrode current collector. The negative electrode mixture layer can contain a negative electrode active material, and optionally a conductive agent and a binder.

Examples of the negative electrode active material include lithium titanate having a ramsdellite structure (for example, Li_{2+y}Ti₃O₇, 0≤y≤3), lithium titanate having a spinel structure (for example, Li₄₊ₓTi₅O₁₂, 0≤x≤3), monoclinic titanium dioxide (TiO₂ (B)), anatase titanium dioxide, rutile titanium dioxide, niobium pentoxide (Nb₂O₅), hollandite titanium composite oxide, orthorhombic titanium-containing composite oxide, and monoclinic niobium titanium composite oxide.

Examples of the orthorhombic titanium-containing composite oxide include a compound represented by Li₂₊ₐM(I)_{2-b}Ti_{6-c}M(II)_{d}O_{14+σ}. Here, M(I) is at least one selected from the group consisting of Sr, Ba, Ca, Mg, Na, Cs, Rb, and K. M(II) is at least one selected from the group consisting of Zr, Sn, V, Nb, Ta, Mo, W, Y, Fe, Co, Cr, Mn, Ni, and Al. The respective subscripts in the composition formulae satisfy 0≤a≤6, 0≤b≤2, 0≤c<6, 0≤d<6, and −0.5≤σ≤0.5. Specific examples of the orthorhombic titanium-containing composite oxide include Li₂₊ₐNa₂Ti₆O₁₄ (0≤a≤6).

Examples of the monoclinic niobium-titanium composite oxide include a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formulae satisfy 0≤x≤5, 0≤y<1, 0≤z<2, and −0.3≤δ≤0.3. Specific examples of the monoclinic niobium-titanium composite oxide include LiₓNb₂TiO₇ (0≤x≤5).

Other examples of the monoclinic niobium-titanium composite oxide include compounds represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formulae satisfy 0≤x≤5, 0≤y≤1, 0≤z<2, and −0.3≤δ≤0.3.

The conductive agent is blended in order to enhance current collection performance and to suppress contact resistance between the electrode active material and the electrode current collector. Examples of the conductive agent include vapor grown carbon fiber (VGCF), carbon black such as acetylene black, and carbonaceous materials such as graphite, carbon nanofibers, and carbon nanotubes. One of them may be used as a conductive agent, or two or more of them may be used in combination as a conductive agent. Alternatively, instead of using the conductive agent, carbon coating or electron conductive inorganic material coating may be applied to the surface of the active material particle.

The binder is blended to fill gaps of the dispersed active material and to bind the active material and the negative electrode current collector. Examples of the binder include polytetrafluoroethylene (PTFE), polyvinylidene fluoride (PVdF), fluororubber, styrene-butadiene rubber (SBR), polyacrylic acid compound, imide compound, carboxymethyl cellulose (CMC), and salts of CMC. One of them may be used as a binder, or two or more of them may be used in combination as a binder.

The blending ratio of the negative electrode active material, the conductive agent, and the binder in the negative electrode mixture layer can be appropriately changed according to the application of the negative electrode. For example, the negative electrode active material, the conductive agent, and the binder are preferably blended in proportions of 68 mass % or more and 96 mass % or less, 2 mass % or more and 30 mass % or less, and 2 mass % or more and 30 mass % or less, respectively. Setting the amount of the conductive agent to 2 mass % or more can improve the current collecting performance of the negative electrode mixture layer. Setting the amount of the binder to 2 mass % or more ensures sufficient property of binding between the negative electrode mixture layer and the current collector, and excellent cycle performance can be expected. On the other hand, the amounts of the conductive agent and the binder are preferably set to 30 mass % or less to increase the capacity.

A material used for the current collector of the negative electrode is a material that is electrochemically stable at a potential at which lithium (Li) is inserted into and extracted from the active material, for example. For example, the negative electrode current collector is preferably made of copper, nickel, stainless steel, aluminum, an aluminum alloy (aluminum alloy containing one or more elements selected from among Mg, Ti, Zn, Mn, Fe, Cu, and Si), or Zn foil, for example. The surface of the Zn foil may be coated with a carbon-containing layer. The thickness of the negative electrode current collector is preferably 5 μm or more and 20 μm or less. The current collector having such a thickness can balance the strength and weight reduction of the electrode.

The current collector may include a portion where the mixture layer is not formed on the surface thereof. This portion can serve as a current collecting tab or a current collecting lead.

### (Aqueous Electrolyte)

The solvent of the aqueous electrolyte is a solvent containing water, and may be water alone or water and a solvent other than water. Examples of the solvent other than water include water-soluble organic solvents. Examples of the water-soluble organic solvent include y-butyrolactone, acetonitrile, alcohols, N-methylpyrrolidone (NMP), dimethylacetamide, dimethylsulfoxide, and tetrahydrofuran. One kind or two or more kinds of solvents can be contained in the aqueous solvent of the electrolyte. In the aqueous solvent of the electrolyte, the content of the solvent other than water is desirably 20 wt % or less.

Whether water is contained in the aqueous electrolyte can be confirmed by gas chromatography-mass spectrometry (GC-MS) measurement. The salt concentration and the water content in the aqueous electrolyte can be measured by inductively coupled plasma (ICP) luminescence analysis, for example. The molar concentration (mol/L) can be calculated by weighing a specified amount of aqueous electrolyte and calculating the concentration of salt contained in the aqueous electrolyte. The number of moles of the solute and solvent can be calculated by measuring the specific gravity of the aqueous electrolyte.

The alkali metal salt contained in the aqueous electrolyte is one or two or more kinds of alkali metal salts selected from the group consisting of Li, Na, and K, for example. Since each of Li, Na, and K is excellent in ion conductivity, the ion conductivity of the aqueous electrolyte can be increased. One kind or two or more kinds of alkali metal salts can be contained in the aqueous electrolyte. It is more preferable an alkali metal salt capable of providing Li⁺ as alkali metal ions by dissolving the alkali metal salt in an aqueous solvent. Therefore, it is more preferable to use a lithium salt as the alkali metal salt in the aqueous electrolyte.

In the aqueous electrolyte, the concentration of the alkali metal ions in the aqueous solvent is preferably 1 mol/L or more and 12 mol/L or less. Increasing the concentration of the alkali metal ions reduces free water molecules in the aqueous electrolyte, thereby suppressing hydrogen generation. The concentration of the alkali metal ions in the aqueous solvent is preferably 4 mol/L or more, and more preferably 5 mol/L or more, even within the above-described range. The concentration of the alkali metal ions in the aqueous solvent is preferably 10 mol/L or less even within the above range.

The alkali metal salt in the aqueous electrolyte is a lithium salt, for example. Examples of the lithium salt include LiCl, LiBr, LiOH, Li₂SO₄, LiNO₃, Li₂C₂O₄, Li₂CO₃, Li[(FSO₂)₂N], Li[(CF₃SO₂)₂N], and LiB[(OCO)₂]₂. One kind or two or more kinds of lithium salts can be used. The lithium salt used is preferably a lithium salt containing LiCl, LiOH, Li[(FSO₂)₂N] or Li[(CF₃SO₂)₂N].

The anions of the alkali metal salt in the aqueous electrolyte contains one or more kinds of ions selected from the group consisting of Cl⁻, Br⁻, OH⁻, SO₄²⁻, NO₃⁻, C₂O₄²⁻, CO₃²⁻, [(FSO₂)₂N]⁻, [(CF₃SO₂)₂N]⁻, and B[(OCO)₂]²⁻, for example. In particular, the anions preferably contain one or more kinds of ions selected from the group consisting of Cl⁻, OH⁻, [(FSO₂)₂N]⁻, and [(CF₃SO₂)₂N]⁻. Accordingly, since the concentration of the alkali metal ions can be increased, hydrogen generation at the negative electrode can be suppressed. As a result, the charge-and-discharge efficiency (coulombic efficiency) of the battery is increased, and the storage performance and the cycle life performance are significantly improved.

In addition, the aqueous electrolyte may be a gel electrolyte containing the above-described composite of an alkali metal salt and a polymer material. If the aqueous electrolyte is a gel electrolyte, diffusion of water molecules from the aqueous electrolyte to the negative electrode can be suppressed, and generation of hydrogen at the negative electrode can be significantly suppressed. Therefore, the cycle life performance and storage performance of the battery can be significantly improved. The composite is a gel-like electrolyte obtained by combining an aqueous solution in which the above-described alkali metal salt is dissolved in an aqueous solvent and a polymer material into a gel state, for example. Examples of the polymer material to be combined with the alkali metal salt include polyacrylate (for example, lithium polyacrylate, potassium polyacrylate, and the like), polyvinylidene fluoride (PVdF), polyacrylonitrile (PAN), and polyethylene oxide (PEO). One kind or two or more kinds of polymer materials can be used. The polymer material may be granular or fibrous, for example. The content of the polymer material in the electrolyte can be in a range of 0.5 wt % or more and 10 wt % or less.

The secondary battery of the embodiment may further include a separator, a container member, a positive electrode terminal, or a negative electrode terminal. Hereinafter, the separator, the container member, the positive electrode terminal, and the negative electrode terminal will be described.

### (Separator)

The separator may be arranged between the positive electrode and the negative electrode, for example. A part of the separator may be in contact with one of the positive electrode or the negative electrode instead of being arranged between the positive electrode and the negative electrode.

The separator may be a porous film including polyethylene (PE), polypropylene (PP), polyethylene terephthalate (PET), cellulose, or polyvinylidene fluoride (PVdF), or a synthetic resin nonwoven fabric, for example. In addition, a separator obtained by applying an inorganic compound or an organic compound to a porous film can also be used. From the viewpoint of safety, it is preferable to use a porous film formed from polyethylene or polypropylene. This is because these porous films can melt at a certain temperature to block the current.

The separator may be a plurality of separators each arranged between the positive electrode and the negative electrode, for example. Alternatively, the separator may be one sheet of separator folded in zigzag. In the latter case, the positive electrode and the negative electrode are alternately arranged in spaces formed by folding the separator.

### (Container Member)

An example of the container member includes a container made of a laminate film or a metal container.

The thickness of the laminate film is 0.5 mm or less, preferably 0.2 mm or less, for example.

As the laminate film, a multilayer film including a plurality of resin layers and a metal layer interposed between the resin layers is used. The resin layer may be made of polypropylene (PP), polyethylene (PE), nylon, and polyethylene terephthalate (PET), for example. The metal layer is preferably made of aluminum foil or aluminum alloy foil for weight reduction. The laminate film can be formed into the shape of the container member by performing sealing through thermal fusion.

The thickness of the wall of the metal container is 1 mm or less, more preferably 0.5 mm or less, and still more preferably 0.2 mm or less, for example.

The metal container is made of aluminum or an aluminum alloy, for example. The aluminum alloy preferably contains elements such as magnesium, zinc, and silicon. If the aluminum alloy contains a transition metal such as iron, copper, nickel, or chromium, the content thereof is preferably 100 ppm by mass or less. In a battery including such a metal container, it is possible to dramatically improve long-term reliability and heat dissipation in a high-temperature environment.

The shape of the container member is not particularly limited. The shape of the container member may be a flat shape (thin shape), a square shape, a cylindrical shape, a coin shape, a button shape, a sheet shape, a stacked shape, or the like, for example. The container member can be appropriately selected according to the size of the battery and the application of the battery. For example, the container member may be a container member for a small-sized battery to be loaded in a portable electronic device or the like. Otherwise, the container member may be a container member for a large-sized battery to be loaded in a vehicle such as a two-wheeled or four-wheeled automobile.

### (Negative Electrode Terminal)

The negative electrode terminal can be formed of a material that is electrically stable in a potential range of 0.8 V (vs. Li/Li⁺) or more and 3 V (vs. Li/Li⁺) or less with respect to the oxidation-reduction potential of lithium (vs. Li/Li⁺) and has conductivity. Specifically, examples of the material for the negative electrode terminal include copper, nickel, stainless steel, aluminum, or an aluminum alloy containing at least one element selected from the group consisting of Mg, Ti, Zn, Mn, Fe, Cu, and Si. As a material for the negative electrode terminal, aluminum or an aluminum alloy is preferably used. The negative electrode terminal is preferably made of the same material as the negative electrode current collector in order to reduce contact resistance with the negative electrode current collector.

### (Positive Electrode Terminal)

The positive electrode terminal can be formed of a material that is electrically stable in a potential range of 3 V (vs. Li/Li⁺) or more and 4.5 V (vs. Li/Li⁺) or less with respect to the oxidation-reduction potential of lithium (vs. Li/Li⁺) and has conductivity. Examples of the material for the positive electrode terminal include titanium, aluminum, or an aluminum alloy containing at least one element selected from the group consisting of Mg, Ti, Zn, Mn, Fe, Cu, and Si. The positive electrode terminal is preferably formed of the same material as the positive electrode current collector in order to reduce contact resistance with the positive electrode current collector.

According to the secondary battery of the first embodiment described above, since the secondary battery includes the gas treatment structure configured to be capable of treating hydrogen gas using an electrical conduction between the gas treatment structure and the positive electrode or by being electrically connected to the positive electrode, it is possible to suppress an increase in internal pressure and to improve charge-and-discharge efficiency.

### Second Embodiment

According to a second embodiment, there is provided a battery pack including the battery according to the embodiment. The battery pack can include a battery module including the battery according to the embodiment. The battery pack may include a single battery instead of a battery module.

The battery pack may further include a protective circuit. The protective circuit has a function of controlling charging and discharging of the secondary battery. Alternatively, a circuit included in a device (for example, an electronic device, an automobile, or the like) using the battery pack as a power source may be used as a protective circuit of the battery pack.

The battery pack may further include an external power distribution terminal. The external power distribution terminal is for outputting a current from the secondary battery to the outside and/or for inputting a current from the outside to the secondary battery. In other words, at the time of use of the battery pack as a power source, a current is supplied to the outside through the external power distribution terminal. At the time of charging the battery pack, a charging current (including regenerative energy of motive power of an automobile or the like) is supplied to the battery pack through the external power distribution terminal.

Next, an example of the battery pack according to the embodiment will be described with reference to the drawings.

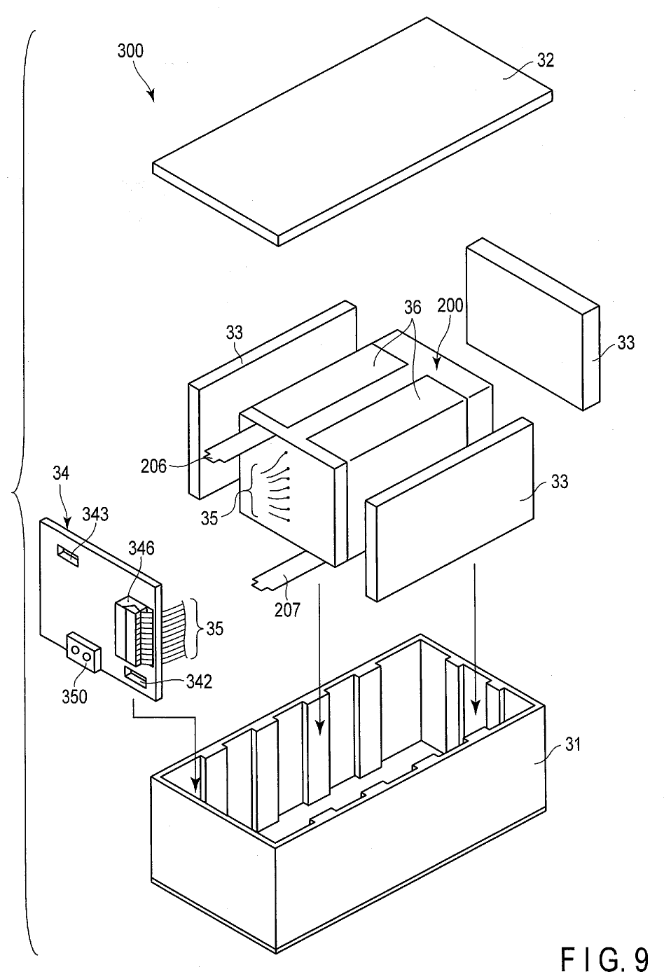

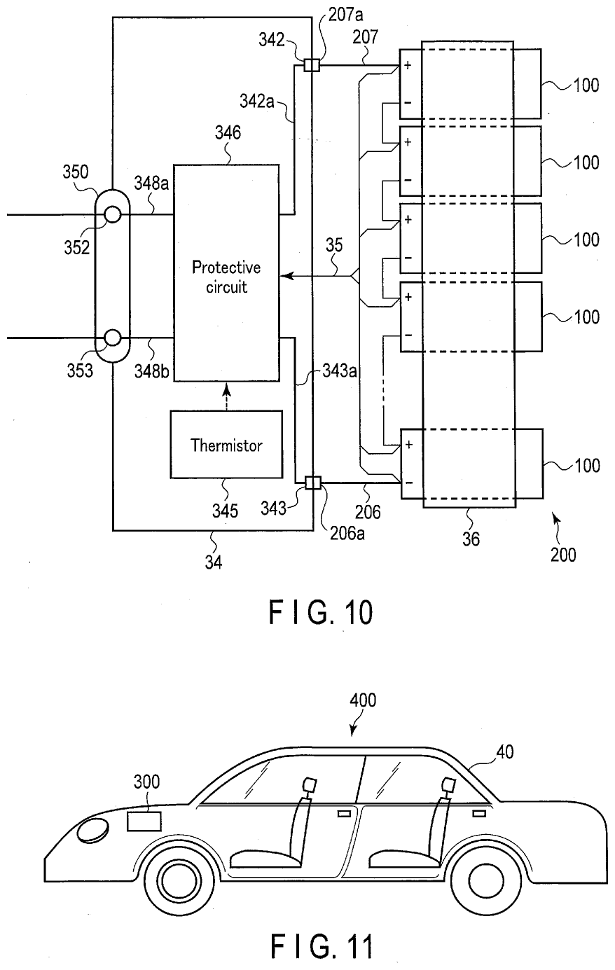

A battery pack 300 illustrated in FIGS. 9 and 10 includes a housing container 31, a lid 32, a protective sheet 33, a battery module 200, a printed wiring board 34, wirings 35, and an insulating plate (not illustrated).

The housing container 31 illustrated in FIG. 9 is a bottomed square container having a rectangular bottom surface. The housing container 31 can store the protective sheet 33, the battery module 200, the printed wiring board 34, and the wirings 35. The lid 32 has a rectangular shape. The lid 32 covers the housing container 31 to store the battery module 200 and others. Although not illustrated, the housing container 31 and the lid 32 are provided with an opening or a connection terminal for connection to an external device or the like.

The battery module 200 includes a plurality of single batteries 100, a positive electrode lead 207, a negative electrode lead 206, and an adhesive tape 36.

At least one of the plurality of single batteries 100 is the secondary battery according to the embodiment. The plurality of single batteries 100 is electrically connected in series as illustrated in FIG. 10. The plurality of single batteries 100 may be electrically connected in parallel, or may be connected in a combination of series connection and parallel connection. If the plurality of single batteries 100 is connected in parallel, the battery capacity increases as compared with the case where they are connected in series.

The adhesive tape 36 fastens the plurality of single batteries 100. Instead of the adhesive tape 36, a heat-shrinkable tape may be used to fix the plurality of single batteries 100. In this case, the protective sheet 33 is arranged on both side surfaces of the battery module 200, the heat-shrinkable tape is wound around, and then the heat-shrinkable tape is heat-shrunk to bind the plurality of single batteries 100.

One end of the positive electrode lead 207 is electrically connected to the battery module 200. One end of the positive electrode lead 207 is electrically connected to the positive electrode of one or more single batteries 100. One end of the negative electrode lead 206 is connected to the battery module 200. One end of the negative electrode lead 206 is electrically connected to the negative electrode of one or more single batteries 100.

The printed wiring board 34 is installed along one of the inner short-side surfaces of the housing container 31. The printed wiring board 34 includes a positive electrode connector 342, a negative electrode connector 343, a thermistor 345, a protective circuit 346, wirings 342a and 343a, an external power distribution terminal 350, a plus wiring (positive wiring) 348a, and a minus wiring (negative wiring) 348b. One main surface of the printed wiring board 34 faces one side surface of the battery module 200. An insulating plate (not illustrated) is interposed between the printed wiring board 34 and the battery module 200.

The other end 207a of the positive electrode lead 207 is electrically connected to the positive electrode connector 342. The other end 206a of the negative electrode lead 206 is electrically connected to the negative electrode connector 343.

The thermistor 345 is fixed to one main surface of the printed wiring board 34. The thermistor 345 detects the temperatures of the single batteries 100 and transmits detection signals thereof to the protective circuit 346.

The external power distribution terminal 350 is fixed to the other main surface of the printed wiring board 34. The external power distribution terminal 350 is electrically connected to a device existing outside the battery pack 300. The external power distribution terminal 350 includes a positive terminal 352 and a negative terminal 353.

The protective circuit 346 is fixed to the other main surface of the printed wiring board 34. The protective circuit 346 is connected to the positive terminal 352 via the positive wiring 348a. The protective circuit 346 is connected to the negative terminal 353 via the minus wiring 348b. The protective circuit 346 is also electrically connected to the positive electrode connector 342 via the wiring 342a. The protective circuit 346 is electrically connected to the negative electrode connector 343 via the wiring 343a. The protective circuit 346 is further electrically connected to the plurality of single batteries 100 via the wirings 35.

The protective sheet 33 is arranged on both inner long side surfaces of the housing container 31 and on an inner short side surface of the housing container 31 facing the printed wiring board 34 with the battery module 200 interposed therebetween. The protective sheet 33 is made of resin or rubber, for example.

The protective circuit 346 controls charging and discharging of the plurality of single batteries 100. The protective circuit 346 also interrupts the electrical connection between the protective circuit 346 and the external power distribution terminal 350 (the positive terminal 352 and the negative terminal 353) to an external device, on the basis of a detection signal transmitted from the thermistor 345 or a detection signal transmitted from each of the single batteries 100 or the battery module 200.

Examples of the detection signal transmitted from the thermistor 345 include a signal obtained by detecting that the temperature of the single battery 100 is equal to or higher than a predetermined temperature. Examples of the detection signal transmitted from each of the single batteries 100 or the battery module 200 include a signal obtained by detecting over-charge, over-discharge, and over-current of the single battery 100. In the case of detecting over-charge of each single battery 100, a battery voltage may be detected, or a positive electrode potential or a negative electrode potential may be detected. In the latter case, a lithium electrode used as a reference electrode is inserted into each single battery 100.

As the protective circuit 346, a circuit included in a device using the battery pack 300 as a power source (for example, an electronic device, an automobile, or the like) may be used.

As described above, the battery pack 300 includes the external power distribution terminal 350. Therefore, the battery pack 300 can output the current from the battery module 200 to an external device and input the current from an external device to the battery module 200 via the external power distribution terminal 350. In other words, when the battery pack 300 is used as a power source, the current from the battery module 200 is supplied to an external device through the external power distribution terminal 350. In the case of charging the battery pack 300, a charging current from an external device is supplied to the battery pack 300 through the external power distribution terminal 350. The use of the battery pack 300 as an in-vehicle battery allows the use of regenerative energy of motive power of the vehicle as a charging current from an external device.

The battery pack 300 may include a plurality of battery modules 200. In this case, the plurality of battery modules 200 may be connected in series, connected in parallel, or connected in a combination of series connection and parallel connection. The printed wiring board 34 and the wirings 35 may be omitted. In this case, the positive electrode lead 207 and the negative electrode lead 206 may be used as the positive-side terminal and the negative-side terminal of the external power distribution terminal, respectively.

This battery pack is used for applications requiring excellent cycle performance in taking out a large current, for example. Specifically, the battery pack is used as a power source of an electronic device, a stationary battery, and an on-vehicle battery of various vehicles, for example. Examples of the electronic device include a digital camera. This battery pack is particularly suitably used as an on-vehicle battery.

The battery pack according to the second embodiment includes the secondary battery according to the embodiment. Therefore, the battery pack can suppress an increase in the internal pressure and can increase the charge-and-discharge efficiency.

### Third Embodiment

According to a third embodiment, there is provided a vehicle including the battery pack according to the embodiment.

In this vehicle, the battery pack is configured to recover regenerative energy of motive power of the vehicle, for example. The vehicle may include a mechanism (regenerator) configured to convert kinetic energy of the vehicle into regenerative energy.

Examples of the vehicle according to the embodiment include a two-wheel or four-wheel hybrid electric automobile, a two-wheel or four-wheel electric automobile, a power-assisted bicycle, and a railway vehicle.

The loading position of the battery pack in the vehicle according to the embodiment is not particularly limited. For example, in the case of the battery pack is loaded into an automobile, the battery pack can be loaded in the engine room of the vehicle, behind the vehicle body, or under a seat.

The vehicle according to the embodiment may include a plurality of battery packs. In this case, the batteries included in the battery packs may be electrically connected in series, electrically connected in parallel, or may be electrically connected in a combination of series connection and parallel connection. For example, if each battery pack includes a battery module, the battery modules may be electrically connected in series, or electrically connected in parallel, or may be electrically connected in combination of series connection and parallel connection. Alternatively, if each battery pack includes a single battery, the single batteries may be electrically connected in series, electrically connected in parallel, or may be electrically connected in combination of series connection and parallel connection.

Next, an example of the vehicle according to the embodiment will be described with reference to the drawings.

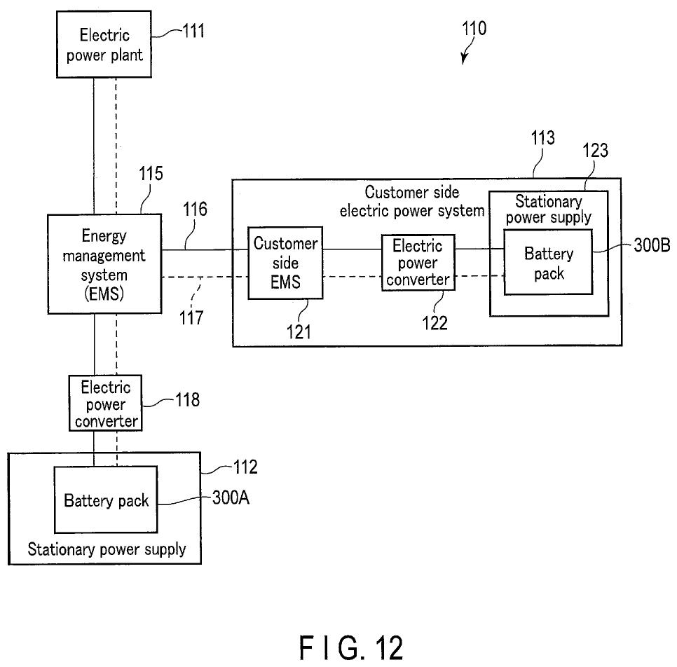

A vehicle 400 illustrated in FIG. 11 includes a vehicle body 40 and a battery pack 300 according to the embodiment. In the example illustrated in FIG. 11, the vehicle 400 is a four-wheeled automobile.

The vehicle 400 may include a plurality of battery packs 300. In this case, the batteries (for example, a single battery or a battery module) included in the battery pack 300 may be connected in series, connected in parallel, or connected in a combination of series connection and parallel connection.

FIG. 11 illustrates an example in which the battery pack 300 is mounted in an engine room located in front of a vehicle body 40. As described above, the battery pack 300 may be mounted behind the vehicle body 40 or under a seat, for example. The battery pack 300 can be used as a power source of the vehicle 400. The battery pack 300 can also capture regenerative energy of the motive power of the vehicle 400.

The vehicle according to the third embodiment includes the battery pack according to the embodiment. Therefore, the vehicle can exhibit high performance and is highly reliable.

### Fourth Embodiment

According to a fourth embodiment, there is provided a stationary power source including the battery pack according to the embodiment. The stationary power source may include the battery module according to the embodiment or the battery according to the embodiment, instead of the battery pack according to the embodiment. The stationary power source can exhibit a long life.

FIG. 12 is a block diagram showing an example of a system including a stationary power supply according to the embodiment. FIG. 12 is a diagram showing an application example to stationary power supplies 112, 123 as an example for use of the battery packs 300A, 300B according to the embodiment. In the example shown in FIG. 12, a system 110 in which the stationary power supplies 112, 123 are used is shown. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control operations to stabilize the entire system 110 by utilizing the electric power network 116 and the communication network 117.

The electric power plant 111 generates a large amount of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current and alternate current, conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control operations to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric car. Also, the system 110 may be provided with a natural energy source. In such a case, the natural energy source generates electric power through natural energy such as wind power and solar light. In addition to the electric power plant 111, electric power is also supplied from the natural energy source through the electric power network 116.

### EXAMPLES

Hereinafter, the above-described embodiments will be specifically described with reference to examples, but the present embodiments are not limited to the following examples unless departing from the gist of the present embodiments.

### Example 1

### (Production of Positive Electrode)

As a positive electrode active material, 100 parts by weight of powder of LiMn₂O₄ was prepared. As a conductive agent, 10 parts by weight of acetylene black was used. As a binder, 10 parts by weight of polyvinylidene fluoride (PVdF) was used. Then, the positive electrode active material, the conductive agent, and the binder are mixed with N-methyl pyrrolidone (NMP) to prepare a slurry. The prepared slurry was applied to both surfaces of the positive electrode current collector. As the positive electrode current collector, titanium foil having a thickness of 15 μm was used. Then, the coating film of the slurry was dried, and then the positive electrode current collector and the coating film were pressed to prepare a positive electrode sheet. The prepared positive electrode sheet was punched out to obtain a positive electrode of a shape including a tab portion of 10 mm×30 mm and an electrode portion (positive electrode mixture layer forming portion) of 30 mm×40 mm.

### (Production of Negative Electrode)

As a negative electrode active material, 100 parts by weight of powder of Li₄Ti₅O₁₂ was used, and as a conductive agent, 10 parts by weight of acetylene black was used. As a binder, 10 parts by weight of PVdF was used. Then, the negative electrode active material, the conductive agent, and the binder were added to and mixed with NMP to prepare a slurry. The prepared slurry was applied to both surfaces of the negative electrode current collector. As the negative electrode current collector, zinc foil having a carbon-contained coating layer with a thickness of 1 μm was used. The negative electrode current collector had a thickness of 15 μm. Then, the coating film of the slurry was dried, and then the negative electrode current collector and the coating film were pressed to prepare a negative electrode sheet. The prepared negative electrode sheet was punched out to form a negative electrode of a shape including a tab portion of 10 mm×30 mm and an electrode portion (negative electrode mixture layer forming portion) of 30 mm×40 mm.

### (Production of Secondary Battery)

The positive electrode and the negative electrode produced as described above were alternately stacked to produce a stack body as an electrode group. In the stack body, a separator was interposed between the positive electrode and the negative electrode. Hard filter paper was used as the separator. In each of the positive electrode and the negative electrode, the terminal was ultrasonically welded to the tab portion. As for the terminal, a titanium ribbon was used as the positive electrode terminal, and an aluminum terminal whose surface was subjected to an anodization treatment was used as the negative electrode terminal. The stack body (electrode group) was housed in a container member made of a laminate film. As the laminate film, a film in which a polypropylene layer was formed on both surfaces of aluminum foil with a thickness of 40 μm was used.

A paste containing platinum-carrying carbon and PVdF as a binder was applied to carbon paper having a size of 30 mm×40 mm at an application amount of 2.0 mg/m², and dried to form a gas treatment layer, thereby producing a gas treatment structure. A Ti wire was fixed to the carbon paper with a tape.

The gas treatment structure was arranged above the electrode group (stack body) at a certain distance from the electrode group. The Ti wire of the gas treatment structure was fixed to the positive electrode terminal of the electrode group by ultrasonic welding, and the gas treatment structure was conducted with the positive electrode.

Then, a 3-ml aqueous solution of 12 M LiCl and 1 M LiOH was supplied as an aqueous electrolyte to the produced electrode group. Thereafter, the laminate film container member was completely sealed by heat sealing. Thus, a laminate cell-type aqueous lithium ion secondary battery was produced.

### Example 2

As illustrated in FIG. 7, a PTFE sheet 25 was on a surface of the carbon paper 13 of the gas treatment structure 5 on which the gas treatment layer was not arranged. The PTFE sheet 25 had grooves 24 with a width of 3 mm and a depth of 0.3 mm were arranged at equal spacings. The grooves 24 in the PTFE sheet 25 were oriented outward, and the surface with no groove was brought into contact with the carbon paper 13. An aqueous lithium ion secondary battery was produced in the same manner as in Example 1 except for the above-described steps.

### Example 3

An aqueous lithium ion secondary battery was produced in the same manner as in Example 2 except that a resistor of 10Ω was interposed in a Ti wire electrically connecting a carbon paper of a gas treatment structure and a positive electrode terminal.

### Example 4

An electrode group was produced in the same manner as in Example 1 except that the outermost layer of an electrode group was produced to be a positive electrode. A gas treatment structure was produced in the same manner as described in relation to Example 1. The gas treatment structure was stacked on a positive electrode positioned at the outermost layer of the electrode group such that carbon paper was in contact with the positive electrode. The positive electrode and the gas treatment structure were not electrically connected by a Ti wire. Therefore, the gas treatment structure was made conductive by being brought into direct contact with the positive electrode. An aqueous lithium ion secondary battery was produced in the same manner as in Example 1 except for the above-described steps.

### Example 5

A positive electrode was produced in the same manner as in Example 1 except that LiNi_{0.5}Co_{0.2}Mn_{0.3}O₂(NCM) was used as a positive electrode active material. An aqueous lithium ion secondary battery was prepared in the same manner as in Example 1 except for using the obtained positive electrode.

### Example 6

Ten gas treatment structures were produced in the same manner as in Example 2 and were stacked on top of each other in layers. A Ti wire was fixed to carbon paper in each layer with a tape, and the tips of the Ti wires were ultrasonically welded to a positive electrode terminal. An aqueous lithium ion secondary battery was produced in the same manner as in Example 1 except for the above-described steps.

### Comparative Example 1

An aqueous lithium ion secondary battery was produced in the same manner as in Example 1 except that no gas treatment structure was provided.

### Comparative Example 2

An aqueous lithium ion secondary battery was produced in the same manner as in Example 5 except that no gas treatment structure was provided.

### (Battery Evaluation)

The produced aqueous lithium ion secondary batteries were subjected to constant-current charge at a current value of 1 C (100 mA in this example) under an environment of 25° C. with a charge potential of 2.7 V and a discharge potential of 2.1 V. Then, after elapse of 1.1 h (1.1 hours) from the start of charging, or based on convergence of the current value to 0.5 C (50 mA in the present example) or less, one charge is terminated. The aqueous lithium ion secondary batteries were subjected to constant-current discharge at 1 C until the voltage reached 2.1 V. The charge and discharge was repeated 20 times, and the cell volumes before and after the charge and discharge were measured to calculate the amount of generated gas.

The charge-and-discharge efficiency (%) of each of the 20 iterations of charge and discharge performed under the above conditions was calculated by 100×{discharge capacity (mAh/g)/charge capacity (mAh/g)}. Table 1 shows the averages of the calculated charge-and-discharge efficiencies. LMO in Table 1 indicates LiMn₂O₄. NCM indicates LiNi_{0.5}Co_{0.2}Mn_{0.3}O₂. TLO indicates Li₄Ti₅O₁₂.

TABLE 1

| | | | | | | | Gas | Average |
|---|---|---|---|---|---|---|---|---|
| | | | | | Connection | | amount | charge- |
| | | | | Number of | method between | | after | and- |
| | | | | stacked | positive electrode | | 20 | discharge |
| | Positive | Negative | | treatment | and gas treatment | Placement position of gas | cycles | efficiency |
| Table 1 | electrode | electrode | Gas treatment structure | structure(s) | structure | treatment structure | (cc) | (%) |
| Example 1 | LMO | TLO | Pt/C-holding carbon paper | 1 | Ti wire | Non-contact with electrode | 2.5 | 85.8 |
| | | | | | | group | | |
| Example 2 | LMO | TLO | Pt/C-holding carbon paper | 1 | Ti wire | Non-contact with electrode | 0.8 | 90.8 |
| | | | (with PTFE gas flow path) | | | group | | |
| Example 3 | LMO | TLO | Pt/C-holding carbon paper | 1 | Ti + 10 Ω resistor | Non-contact with electrode | 1.1 | 95.8 |
| | | | (with PTFE gas flow path) | | | group | | |
| Example 4 | LMO | TLO | Pt/C-holding carbon paper | 1 | Direct contact | Surface contact with | 0.2 | 91.1 |
| | | | | | | positive electrode of | | |
| | | | | | | electrode group | | |
| Example 5 | NCM | TLO | Pt/C-holding carbon paper | 1 | Ti wire | Non-contact with electrode | 2.2 | 86.2 |
| | | | | | | group | | |
| Example 6 | LMO | TLO | Pt/C-holding carbon paper | 10 | Ti wire | Non-contact with electrode | 0 | 89 |
| | | | (with PTFE gas flow path) | | | group | | |
| Comparative | LMO | TLO | None | — | — | — | 12.2 | 84.2 |
| example 1 | | | | | | | | |
| Comparative | NCM | TLO | None | — | — | — | 10.4 | 85.4 |
| example 2 | | | | | | | | |

As is apparent from Table 1, the secondary batteries of Examples 1 to 6 including the gas treatment structure have smaller amounts of gas after 20 charge-and-discharge cycles and higher average charge-and-discharge efficiencies than the secondary batteries of Comparative Examples 1 and 2 not including the gas treatment structure.

According to the secondary battery of at least one of the embodiments or examples, since the secondary battery includes the gas treatment structure configured to be capable of treating hydrogen gas using an electrical conduction between the gas treatment structure and the positive electrode, it is possible to suppress an increase in internal pressure and to improve charge-and-discharge efficiency.

Hereinafter, the embodiments will be additionally described.

<1> A secondary battery including:
a positive electrode;
a negative electrode;
an aqueous electrolyte; and
a gas treatment structure configured to be capable of treating hydrogen gas using an electrical conduction between the gas treatment structure and the positive electrode.

<2> The secondary battery according to <1>, in which the gas treatment structure includes a conductive porous substrate and a gas treatment layer provided on the porous substrate and containing at least one of a hydrogen storage alloy or a noble metal catalyst.

<3> The secondary battery according to <1>, in which the gas treatment structure includes: a conductive porous substrate; a gas treatment layer provided on one surface of the porous substrate and containing at least one of a hydrogen storage alloy or a noble metal catalyst; and a layer provided on the other surface of the porous substrate and having a gas flow path.

<4> The secondary battery according to any one of <1> to <3>, in which the gas treatment structure is electrically connected to the positive electrode via a resistor.

<5> The secondary battery according to any one of <1> to <3>, in which the gas treatment structure is electrically connected to the positive electrode via a switching element.

<6> The secondary battery according to <2>, in which the porous substrate of the gas treatment structure is in contact with the positive electrode.

<7> The secondary battery according to any one of <1> to <6>, in which the secondary battery is a lithium ion secondary battery.

<8> A battery pack including the secondary battery according to any one of <1> to <7>.

<9> The battery pack described in <8>, further including an external power distribution terminal and a protective circuit.

<10> The battery pack according to <8> or <9>, including a plurality of the secondary battery, in which the secondary batteries are electrically connected in series, in parallel, or in a combination of series connection and parallel connection.

<11> A vehicle including the battery pack according to any one of <8> to <10>.

<12> The vehicle according to <11>, including a mechanism configured to convert kinetic energy of the vehicle into regenerative energy.

<13> A stationary power source including the battery pack according to any one of <8> to <10>.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
a positive electrode;
a negative electrode;
an aqueous electrolyte; and
a gas treatment structure configured to be capable of treating hydrogen gas using an electrical conduction between the gas treatment structure and the positive electrode.

2. The secondary battery according to claim 1, wherein the gas treatment structure comprises:
a conductive porous substrate; and
a gas treatment layer provided on the porous substrate and comprising at least one of a hydrogen storage alloy or a noble metal catalyst.

3. The secondary battery according to claim 1, wherein the gas treatment structure comprises:
a conductive porous substrate;
a gas treatment layer provided on one surface of the porous substrate and comprising at least one of a hydrogen storage alloy or a noble metal catalyst; and
a layer provided on the other surface of the porous substrate and having a gas flow path.

4. The secondary battery according to claim 1, wherein the gas treatment structure is electrically connected to the positive electrode via a resistor.

5. The secondary battery according to claim 1, wherein the gas treatment structure is electrically connected to the positive electrode via a switching element.

6. The secondary battery according to claim 2, wherein the porous substrate of the gas treatment structure is in contact with the positive electrode.

7. The secondary battery according to claim 1, wherein the secondary battery is a lithium ion secondary battery.

8. A battery pack comprising the secondary battery according to claim 1.

9. The battery pack according to claim 8, further comprising:
an external power distribution terminal; and
a protective circuit.

10. The battery pack according to claim 9, comprising a plurality of the secondary battery, wherein the secondary batteries are electrically connected in series, in parallel, or in combination of series and parallel.

11. A vehicle comprising the battery pack according to claim 8.

12. The vehicle according to claim 11, comprising a mechanism configured to convert kinetic energy of the vehicle into regenerative energy.

13. A stationary power source comprising the battery pack according to claim 8.
